(19) United States
(12) Patent Application Publication
(10) Pub. No.: US 2016/0327783 A1
(43) Pub. Date: Nov. 10, 2016

(54) PROJECTION DISPLAY SYSTEM AND METHOD

(71) Applicants: HISENSE ELECTRIC CO., LTD., Shandong (CN); HISENSE USA CORPORATION, Suwanee, GA (US); HISENSE INTERNATIONAL CO.,LTD., Shandong (CN)

(72) Inventors: Aichen XU, Shandong (CN); Shubin ZHAO, Shandong (CN)

(21) Appl. No.: 15/212,862

(22) Filed: Jul. 18, 2016

(30) Foreign Application Priority Data
Feb. 29, 2016 (CN) 201610110142.2
Mar. 2, 2016 (CN) 201610118184.0

(51) Int. Cl. G02B 26/08; H04N 9/31

(52) U.S. Cl. CPC G02B 26/0833; H04N 9/3155; H04N 9/317; H04N 9/3179

(57) ABSTRACT

The application disclose a projection display system and method, and the projection display system includes a light source module, a DMD, and an imaging module, wherein the light source module is configured to illuminate the DMD with light rays emitted periodically at different angles; and the DMD is configured to receive the light rays emitted by the light source module according to a corresponding relationship between an angle and a part of image, and to reflect the received light rays emitted by the light source module in response to a driver signal corresponding to any part of image to be displayed, to thereby generate and transmit reflected light rays corresponding to respective pixels of the part of image to the imaging module.

This application claims the benefit of Chinese Patent Application No. 201610110142.2, filed with the Chinese Patent Office on Feb. 29, 2016 and entitled “Projection display method and system”, and Chinese Patent Application No. 201610118184.0, filed with the Chinese Patent Office on Mar. 2, 2016 and entitled “Projection display system and method”, both of which are hereby incorporated by reference in their entireties.

### FIELD

The present application relates to the field of display technologies, and particularly to a projection display system and method.

### BACKGROUND

A Digital Micro-mirror Device (DMD) is a core device in the industries of a projector, a laser TV set, etc., at present, and it is such a fully digitalized spatial light modulator that controls the color and grayscale of an image precisely through rapid switching and pulse width modulation. There is a two-dimension array of micro mirrors distributed throughout the surface of the DMD, where each micro mirror corresponds to a pixel in a projection picture , and the respective micro mirrors can be deflected freely at different deflection angles so that they will appear in different states. Thus light rays are controlled to be reflected by the reflection angle of each micro mirror to thereby display the image in real time. However the improvement of resolution for the DMD may be constrained by the process of fabricating the DMD, and if the required imaging resolution is beyond the limitation of resolution available from the DMD, then it may be difficult to improve the resolution of the DMD simply by improving the process of fabricating the DMD.

In order to display the picture at a higher resolution, the number of DMDs may be increased as proposed in the prior art, but this solution may be expensive, and also make it complex to control the DMDs in view of required consistency among display parameters of the different DMDs, and their synchronized control.

In summary, the picture can not be displayed at a higher resolution using single DMDs in the prior art.

### SUMMARY

Embodiments of the application provide a projection display system and method so as to display a picture at a higher resolution without increasing the number of DMDs.

An embodiment of the application provides a projection display system including a light source module, a Digital Micro-mirror Device (DMD), and an imaging module, wherein:

the light source module is configured to illuminate the DMD with light rays emitted periodically at different angles;

the DMD is configured to receive the light rays emitted by the light source module according to a corresponding relationship between an angle and a part of image, and to reflect the received light rays emitted by the light source module in response to a driver signal corresponding to any part of an image to be displayed, to thereby generate and transmit reflected light rays corresponding to respective pixels of the part of image to the imaging module, wherein the corresponding relationship between an angle and a part of image defines that an angle at which the light rays emitted by the light source module illuminate the DMD corresponds to one part of the image to be displayed; and

the imaging module is configured to image the reflected light rays, emitted by the DMD, corresponding to the respective pixels in the respective image components, in different imaging areas of a display screen according to a corresponding relationship between an angle and an imaging area, wherein the respective parts of image constitute the entire image; and the corresponding relationship between an angle and an image area defines that an angle at which the light rays emitted by the light source module illuminate the DMD corresponds to one of the imaging areas of the display screen.

An embodiment of the application provides a projection display method including:

segmenting an image to be displayed, into at least two parts, and generating a digital signal of each part of image;

illuminating a Digital Micro-mirror Device (DMD) periodically with light rays of light sources at different angles according to a one-to-one corresponding relationship between angles at which light rays of light sources illuminate the DMD, and the respective parts of the image to be displayed, and outputting the digital signals of the respective parts of image respectively to the DMD, wherein the timing at which the light rays of the light resources at the respective angles illuminate the DMD is synchronized with the timing at which the digital signals of the respective component images are output respectively to the DMD; and

imaging reflected light rays corresponding to respective pixels of the respective parts of image emitted by the DMD, in different imaging areas of a display screen according to a one-to-one corresponding relationship between the angles at which the light rays of the light sources illuminate the DMD, and the respective imaging areas of the display screen, wherein the parts of image in the respective imaging areas constitute the entire image.

### BRIEF DESCRIPTION OF THE DRAWINGS

FIG. 1 is a schematic structural diagram of a display system for an image at a high resolution according to an embodiment of the application;

FIG. 2 is a schematic structural diagram of a projection display system according to an embodiment of the application;

FIG. 3 is a schematic structural diagram of a first variant of the projection display system according to an embodiment of the application;

FIG. 4 is a schematic structural diagram of a first light source module in the projection display system according to an embodiment of the application;

FIG. 5 is a schematic structural diagram of a DMD in the projection display system according to an embodiment of the application;

FIG. 6A is a schematic diagram of reflected light rays in one state from incident light at DMD micro mirrors according to an embodiment of the application;

FIG. 6B is a schematic diagram of reflected light rays in one state from incident light at DMD micro mirrors according to an embodiment of the application;

FIG. 6C are schematic diagram of reflected light rays in one state from incident light at DMD micro mirrors according to an embodiment of the application;

FIG. 7 is a schematic structural diagram of a first imaging module in the projection display system according to an embodiment of the application;

FIG. 8 is a schematic diagram of a second variant of the projection display system according to an embodiment of the application;

FIG. 9 is a schematic structural diagram of a second light source module in the projection display system according to an embodiment of the application;

FIG. 10 is a schematic diagram of a third variant of the projection display system according to an embodiment of the application;

FIG. 11 is a schematic structural diagram of a third light source module in the projection display system according to an embodiment of the application;

FIG. 12 is a schematic diagram of a fourth variant of the projection display system according to an embodiment of the application;

FIG. 13 is a schematic structural diagram of a second imaging module in the projection display system according to an embodiment of the application; and

FIG. 14 is a schematic flow chart of a projection display method according to an embodiment of the application.

### DETAILED DESCRIPTION OF THE EMBODIMENTS

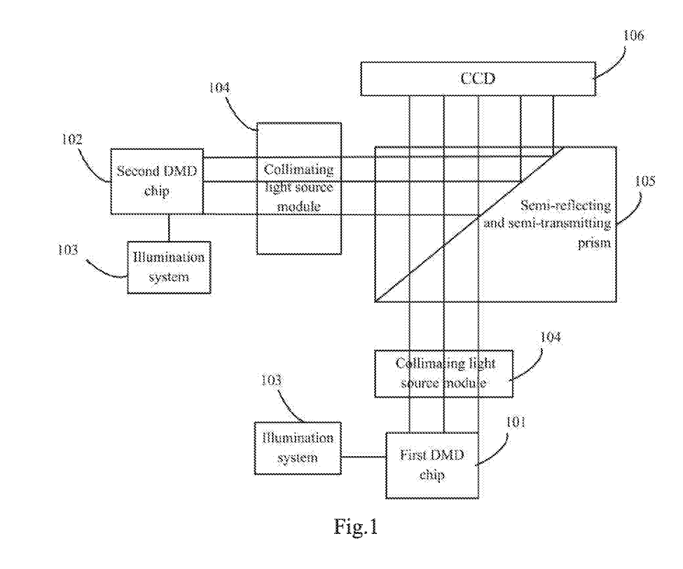

In order to improve the resolution of a picture, it may be feasible to increase the number of DMDs, and a corresponding display system can be structured as illustrated in FIG. 1, and can operate generally under the following principle: an image to be displayed (at the resolution of 4K*4K) is segmented into two 4K*2K images (e.g., images including 3840*2160 pixels, where the intrinsic resolution of DMDs in use is 4K*2K) transmitted respectively to two DMD chips (i.e., a first DMD chip 101 and a second DMD chip 102); a DMD driver module enables the first DMD chip 101 and the second DMD chip 102 to operate concurrently, and a LED driver module drives an illumination system to operate, so that the first DMD chip 101 and the second DMD chip 102 are illuminated by the illumination system 103 to generate images, where the image emitted from the second DMD chip 102 passes through a collimating optical system 104, and then is incident as parallel light into an optical splicing module 105 (e.g., a semi-reflecting and semi-transmitting prism), and a reflection image on a CCD 106 is generated by a semi-reflecting and semi-transmitting membrane, and the image emitted from the first DMD chip 101 passes through the collimating optical system 104, and then is incident as parallel light into the optical splicing module 105, and a transmission image on the CCD 106 is generated by the semi-reflecting and semi-transmitting membrane, so that the reflection image and the transmission image are spliced together after mechanical alignment until their edges are merged into respective pixels to thereby display the image at the resolution of 4K*4K.

Embodiments of the application provide a projection display system and method so as to display an image at a higher resolution without increasing the number of DMDs.

With the embodiments of the application, the light source illuminating the DMD, the control on the light source, the driving of the DMD, the imaging module, etc., can be improved over the existing single DMD projection system to thereby display a picture at a higher resolution using the single DMD in the existing specification.

All the images generated by a projection display system according to an embodiment of the application are generated under the same principle, and the principle of imaging by a projection display system according to an embodiment of the application will be described below by way of an example in which an image is generated.

An image to be displayed is segmented into at least two image components, and light rays from a light source at an angle to illuminate a DMD correspond to one part of the image to be displayed, and an imaging area of a display screen, so that the DMD is illuminated alternately by light rays at different angles from the light source, and the same DMD generates each part of the image to be displayed, in the corresponding imaging area of the display screen in a time-division mode, so the parts of image in the respective imaging areas constitute the entire image.

The embodiments of the application will be described below.

An embodiment of the application provides a projection display system including a light source module, a DMD, and an imaging module, where:

The light source module is configured to illuminate the DMD with light rays emitted periodically at different angles;

The DMD is configured to receive the light rays emitted by the light source module according to a corresponding relationship between an angle and a part of image, and to reflect the received light rays emitted by the light source module in response to a driver signal corresponding to any part of the image to be displayed, to thereby generate and transmit reflected light rays corresponding to respective pixels of the part of image to the imaging module, where the corresponding relationship between an angle and a part of image defines that an angle at which the light rays emitted by the light source module illuminate the DMD corresponds to one part of the image to be displayed; and

The imaging module is configured to image the reflected light rays, emitted by the DMD, corresponding to the respective pixels in the respective parts of image, in different imaging areas of a display screen according to a corresponding relationship between an angle and an imaging area, where the respective parts of image in the respective imaging areas constitute the entire image; and the corresponding relationship between an angle and an image area defines that an angle at which the light rays emitted by the light source module illuminate the DMD corresponds to one of the imaging areas of the display screen.

Where the corresponding relationship between an angle and an imaging area is preset before the projection display system is shipped from a factory, for example, if light rays from a light source at a first angle illuminate the DMD, then the imaging area of the display screen corresponding thereto will be a first imaging area; and if light rays from a light source at a second angle illuminate the DMD, then the imaging area of the display screen corresponding thereto will be a second imaging area.

The corresponding relationship between an angle and a part of image is preset based upon the corresponding relationship between an angle and an imaging area, and if a certain part of the image to be displayed needs to be generated in a specific imaging area of the display screen, accordingly the DMD will be illuminated by light rays from a light source at a specific angle, so the angle at which the light rays emitted by the light source module illuminate the DMD will correspond to the respective parts of the image to be displayed, for example, the light rays from the light source at the first angle correspond to a first part of the image to be displayed, and the light rays from the light source at the second angle correspond to a second part of the image to be displayed.

In some implementations, the light source module includes a number of light sources arranged at different angles; and the light sources are lightened in a time order to thereby emit light rays periodically to illuminate the DMD.

Alternatively, the light source module includes one light source, then a reflecting mirror which can be rotated in a time order will be arranged in an optical path of the light source, where the reflecting mirror is positioned to be rotated at a number of angles; and the light source is lightened constantly to output light rays at a corresponding angle for any one of the rotation angles to illuminate the DMD, where the light source can be an ultra-high pressure mercury lamp light source, a Light Emitting Diode (LED) light source, a laser light source, etc., where the laser light source emits light rays at high brightness in a preferable color gamut.

In some implementations, the imaging module includes an optical merging element and a projection lens, where:

The optical merging element is configured to adjust the directions of the reflected light rays corresponding to the respective pixels of the respective parts of the image emitted by the DMD so that they are incident in parallel onto different areas of the projection lens; and

The projection lens is configured to focus and image the reflected light rays corresponding to the respective pixels of the respective parts of image, emitted by the DMD, passing through the optical merging element, in the different imaging areas of the display screen, according to the corresponding relationship between an angle and an imaging area.

Of course, in some implementations, the projection display system above can further include a signal processing system configured to segment the image to be displayed into at least two parts, to generate a digital signal of each part, and to output the digital signals of the respective parts of the image respectively to the DMD.

In some embodiments, the projection display system above can further include a synchronization control apparatus configured to generate and transmit a synchronization control signal respectively to the signal processing system and the light source module, where the synchronization control signal is configured to control the timing at which the light rays emitted by the light source module illuminate the DMD to be synchronized with the timing at which the signal processing system outputs the digital signals of the respective parts of the image to the DMD, according to the corresponding relationship between an angle and a part of image.

It shall be noted that the synchronization control signal can alternatively be generated otherwise, for example, it can be generated by some system which can function as both the signal processing system and the synchronization control apparatus. The embodiment of the application will not be limited to any particular scheme to generate the synchronization control signal as long as the same DMD generates each part of the image to be displayed, in the corresponding imaging area of the display screen, in a time-division mode.

Moreover with the projection display system according to the embodiment of the application, the resolution of the image in a single dimension (e.g., the wide direction or the length direction) can be improved, and in principle, the resolutions of the image in two dimensions (e.g., both the wide direction and the length direction) can be improved, where the image is segmented into at least four parts, the number of which is an even number.

The technical solution according to the embodiment of the application will be described below with reference to the drawings by way of an example in which an image is segmented into two parts to be displayed by a projection display system including a signal processing system and a synchronization control apparatus according to an embodiment of the application.

The arrowed lines throughout the drawings in the embodiments of the application represent the directions in which light rays are transmitted, instead of connection relationships.

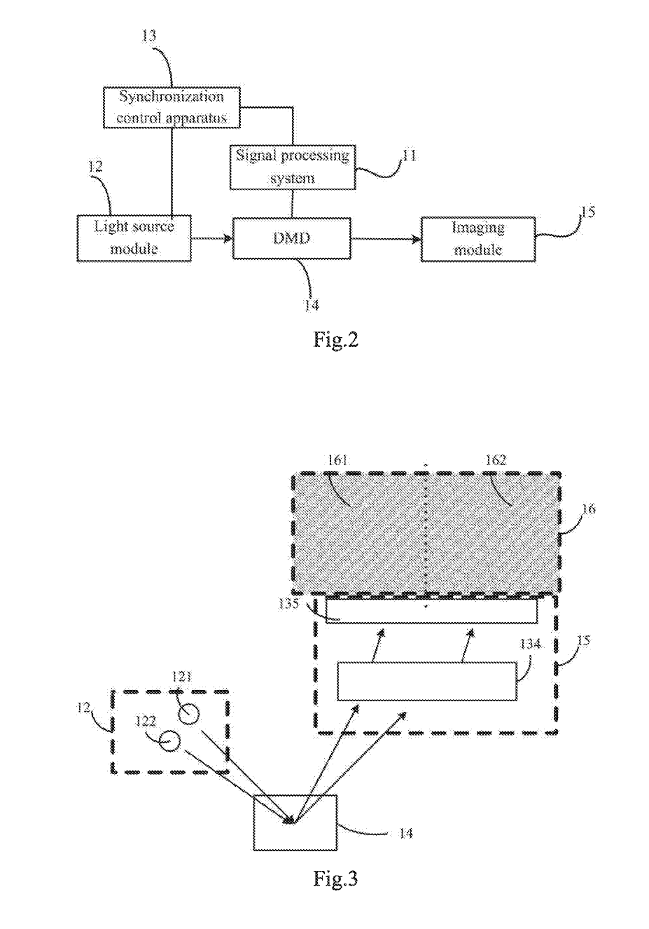

As illustrated in FIG. 2, a projection display system according to an embodiment of the application includes a signal processing system 11, a light source module 12, a synchronization control apparatus 13, a DMD 14, and an imaging module 15, where:

The signal processing system 11 is configured to segment an image to be displayed, into a first part and a second part, and to generate a digital signal of each parts of the image; and to receive a synchronization control signal emitted by the synchronization control apparatus 13, and to output the digital signals of the first part and the second part respectively to the DMD 14 in response to the synchronization control signal, where the first part and the second part of the image are respective halves of the image to be displayed, and the first and the second parts can be the left and right halves, or the upper and lower halves thereof;

The light source module 12 is configured to receive the synchronization control signal emitted by the synchronization control apparatus 13, and to emit light rays alternately at a first angle and a second angle in response to the synchronization control signal to illuminate the DMD 14;

The synchronization control apparatus 13 is configured to generate synchronization control signal, and transmit the synchronization control signal respectively to the signal processing system 11 and the light source module 12, where the synchronization control signal is configured to control the timing at which the light rays emitted by the light source module 12 illuminate the DMD 14 to be synchronized with the timing at which the signal processing system 11 outputs the digital signals of the respective image components to the DMD 14, according to a corresponding relationship between an angle and a part of image, which defines that the light rays of the light source at the first angle correspond to the first part if the image to be displayed, and the light rays of the light source at the second angle correspond to the second part of the image to be displayed;

The DMD 14 is configured to receive the light rays of a light source at the first angle, and the digital signal of the first part emitted by the signal processing system 11, to generate a driver signal corresponding to the digital signal of the first part of image, and to reflect the light rays of the light source at the first angle in response to the driver signal to generate reflected light rays corresponding to respective pixels of the first part of the image, where the reflected light rays are focused and imaged by the imaging module 15 in a first imaging area of a display screen (that is, the first part of image is displayed); and to receive the light rays of a light source at the second angle, and the digital signal of the second part emitted by the signal processing system 11, to generate a driver signal corresponding to the digital signal of the second part of image, and to reflect the light rays of the light source at the second angle in response to the driver signal to generate reflected light rays corresponding to respective pixels of the second part of image, where the reflected light rays are focused and imaged by the imaging module 15 in a second imaging area of the display screen (that is, the second part of image is displayed), according to the timing at which the light rays of the light source at the first angle, and the light rays of the light source at the second angle are output, and the corresponding relationship between an angle and a part of image; and

The imaging module 15 is configured to image the reflected light rays corresponding to the respective pixels of the first part emitted by the DMD 14, in the first imaging area of the display screen according to a corresponding relationship between an angle and an imaging area; and to image the reflected light rays corresponding to the respective pixels of the second part emitted by the DMD 14, in the second imaging area of the display screen according to the corresponding relationship between an angle and an imaging area, where the parts in the first imaging area and the second imaging area constitute the entire image; and the corresponding relationship between an angle and an imaging area defines that the light rays of the light source at the first angle correspond to the first imaging area of the display screen, and the light rays of the light source at the second angle correspond to the second imaging area of the display screen.

In some implementations, the signal processing system 11, the synchronization control apparatus 13, and the DMD 14 can be arranged separately in the projection display system, or the signal processing system 11, the synchronization control apparatus 13, and the DMD 14 can be integrated in such an optical device of the projection display system, to thereby perform the respective functions of the signal processing system 11, the synchronization control apparatus 13, and the DMD 14.

With the technical solution according to the embodiment of the application, the image to be displayed is segmented, for example, into two parts, i.e., the first part of image and the second part of image, and the light sources emit alternately the light rays of the light sources at different angles, i.e., the light rays of the light source at the first angle, and the light rays of the light source at the second angle, so that the light rays of the light sources at the different angles provide illumination for the different parts of the image to be displayed, and modulate the different display pictures, thus resulting the respective parts of the image being output and displayed sequentially. Since the light rays of the light source at the first angle, and the light rays of the light source at the second angle alternate, the first projection image and the second projection image are output alternately to thereby constitute the entire image due to persistence of vision in human eyes, where the size of the projection image is doubled in the direction in which the image is segmented, so that the image can be displayed at a large size by the projection display device including the single DMD while controlling simply and conveniently the angles of light beams to be varied in synchronization with the output of pictures only.

Furthermore in the technical solution above, since the image to be displayed is segmented, the segmented parts are output in a time-division mode and displayed at the same resolution, the resolution of the entire image can be doubled in the direction in which the image is segmented, to obtain the effect of improving the resolution of the image in the single dimension.

Several embodiments of the structure of a projection display system according to an embodiment of the application will be described below with reference to the drawings.

Referring to FIG. 3, a projection display system according to an embodiment of the application includes a signal processing system (not illustrated in FIG. 3), a light source module 12, a synchronization control apparatus (not illustrated in FIG. 3), a DMD 14, and an imaging module 15, where:

The signal processing system 11 is configured to segment an image to be displayed, into a first part and a second part of image, and to generate a digital signal of each part; and to receive a synchronization control signal emitted by the synchronization control apparatus, and to output the digital signals of the first and the second parts respectively to a driver apparatus in the DMD 14 in response to the synchronization control signal, where the first and the second parts are respective halves of the image to be displayed, and the first and the second parts can be the left and right halves, or the upper and lower halves thereof. If the first part and the second part of the image are the upper and lower halves of the image, then there will be a vertical angle between light rays of a light source at a first angle, and light rays of a light source at a second angle, and if the first and the second parts of image are the left and right halves of the image, then there will be a horizontal angle between the light rays of the light source at the first angle, and the light rays of the light source at the second angle.

If the image to be displayed is segmented into the left and right halves of the image, then the first and the second parts of image will share the same light source module due to the fixed resolution of the DMD, so the two parts can be projected in areas of the same size but at different positions, so that the image can be segmented into and displayed as the two parts at the same resolution, and in the horizontal direction, both the size and the resolution of the entire image can be doubled to thereby improve the quality of the image, where the horizontal direction here refers to the direction in which the left and right halves of the image can be spliced into the entire image to be displayed, which can be also regarded as the left-right direction.

If the image to be displayed is segmented into the upper and lower halves of the image, then in the vertical direction, both the size and the resolution of the image can be doubled to thereby improve the quality of the image, where the vertical direction here refers to the direction in which the upper and lower halves of the image can be spliced into the entire image to be displayed, which can be also regarded as the top-bottom direction.

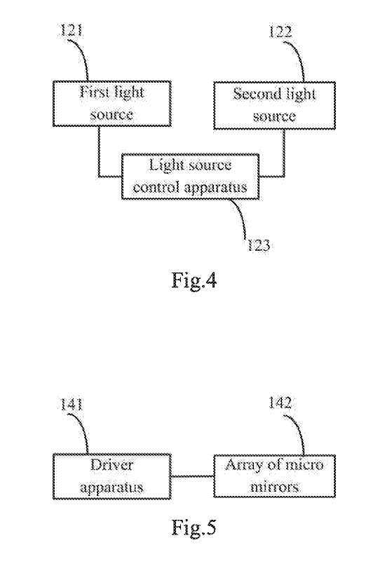

As illustrated in FIG. 4, the light source module 12 includes the first light source 121, the second light source 122, and a light source control apparatus 123 (not illustrated in FIG. 3), where the first light source 121 and the second light source 122 are arranged at different angles; and the light source control apparatus 123 is configured to receive the synchronization control signal emitted by the synchronization control apparatus, and to control the first light source 121 or the second light source 122 in response to the synchronization control signal to be lightened in time order to thereby emit the light rays alternately at the first angle or the second angle respectively to illuminate an array of micro mirrors of the DMD 14, where both of the first light source and the second light source can illuminate the entire DMD. The light sources can be ultra-high pressure mercury lamp light sources, LED light sources, laser light sources, etc., where the laser light source are preferred; and the laser light sources can be hybrid light sources which are composed of laser and fluorescence, or can be pure laser light sources. For example, the light sources can include lasers, fluorescence wheels, filter wheels, and an optical path including a number of lenses and reflecting mirrors, where light beams of the light sources passing through the filter wheels can be timed to be output as highly pure three primary colors of RGB or four primary colors of RGBY.

The synchronization control apparatus is configured to generate the synchronization control signal, and transmit the synchronization control signal respectively to the signal processing system 11 and the light source module 12, where the synchronization control signal is configured to control the timing at which the light rays emitted by the light source module 12 illuminate the DMD 14 to be synchronized with the timing at which the signal processing system 11 outputs the digital signals of the respective parts of image to the DMD 14, according to a corresponding relationship between an angle and a part of image, which defines that the light rays of the light source at the first angle correspond to the first part of image to be displayed, and the light rays of the light source at the second angle correspond to the second part of image to be displayed.

As illustrated in FIG. 5, the DMD 14 includes the driver apparatus 141 and the array of micro mirrors 142, where:

The driver apparatus 141 is configured to receive the digital signal of the first part of image emitted by the signal processing system 11, to generate a first drive signal corresponding to the digital signal of the first part of image, and to control the respective micro mirrors in the array of micro mirrors 142 in response to the first driver signal to reflect the light rays of the light source at the first angle to generate reflected light rays corresponding to respective pixels of the first part of iamge, where the reflected light rays are focused and imaged by the imaging module 15 in a first imaging area 161 of a display screen 16 (that is, the first part of image is displayed); and to receive the digital signal of the second part of image emitted by the signal processing system 11, to generate a drive signal corresponding to the digital signal of the second part of image, and to control the respective micro mirrors in the array of micro mirrors 142 to reflect the light rays of the light source at the second angle in response to the second driver signal to generate reflected light rays corresponding to respective pixels of the second part of image, where the reflected light rays are focused and imaged by the imaging module 15 in a second imaging area 162 of the display screen 16 (that is, the second part of image is displayed), according to the timing at which the light rays of the light source at the first angle, and the light rays of the light source at the second angle are output, and the corresponding relationship between an angle and a part of image.

Particularly the driver apparatus 141 can be a DMD driver chip, for example.

Particularly, the driver apparatus 141 configured to control the respective micro mirrors in the array of micro mirrors 142 in response to the first driver signal corresponding to the digital signal of the first part of image to reflect the light rays of the light source at the first angle to generate the reflected light rays corresponding to the respective pixels of the first part of image, is configured to control the respective micro mirrors in the array of micro mirrors 142 in response to the first driver signal to be deflected at different angles to thereby reflect light in different colors so as to enable different amounts of light to enter the imaging module 15, where the first driver signal is a control signal to control the angles and the timing at which the respective micro mirrors are deflected. The light rays of the light source at the first angle are reflected in response to the first driver signal to generate the reflected light rays corresponding to the respective pixels of the first part of image. That is, amounts of light corresponding to gray-scale values of the part of image to be displayed are generated respectively for the light rays in the different three primary colors of RGB dependent upon the colors of the respective pixels in the part of image, and this process can be regarded as a process in which the light rays of the light source at the first angle are modulated according to the first part of image so that these reflected light rays enter the imaging module 15.

Particularly, the driver apparatus 141 configured to control the respective micro mirrors in the array of micro mirrors 142 in response to the second driver signal corresponding to the digital signal of the second part of image to reflect the light rays of the light source at the second angle to generate the reflected light rays corresponding to the respective pixels of the second part of image, is configured to control the respective micro mirrors in the array of micro mirrors 142 in response to the second driver signal to be deflected at different angles to thereby reflect light in different colors so as to enable different amounts of light to enter the imaging module 15, where the second driver signal is a control signal to control the angles and the timing at which the respective micro mirrors are deflected. The light rays of the light source at the second angle are reflected in response to the second driver signal to generate the reflected light rays corresponding to the respective pixels of the second part of image. That is, amounts of light corresponding to gray-scale values of the image component to be displayed are generated respectively for the light rays in the different three primary colors of RGB dependent upon the colors of the respective pixels in the part of image, and this process can be regarded as a process in which the light rays of the light source at the second angle are modulated according to the second part of image so that these reflected light rays enter the imaging module 15.

The array of micro mirrors 142 is configured to receive the light rays of a light source at the first angle, and to be controlled by the driver apparatus 141 to reflect the light rays of the light source at the first angle to generate the reflected light rays corresponding to the respective pixels of the first part of image, where the reflected light rays are focused and imaged by the imaging module 15 in the first imaging area 161 of the display screen 16 (that is, the first part of image is displayed); and to receive the light rays of a light source at the second angle, and to be controlled by the driver apparatus 141 to reflect the light rays of the light source at the second angle to generate the reflected light rays corresponding to the respective pixels of the second part of image, where the reflected light rays are focused and imaged by the imaging module 15 in the second imaging area 162 of the display screen 16 (that is, the second part of image is displayed), according to the timing at which the light rays of the light source at the first angle, and the light rays of the light source at the second angle are output, and the corresponding relationship between an angle and a part of image.

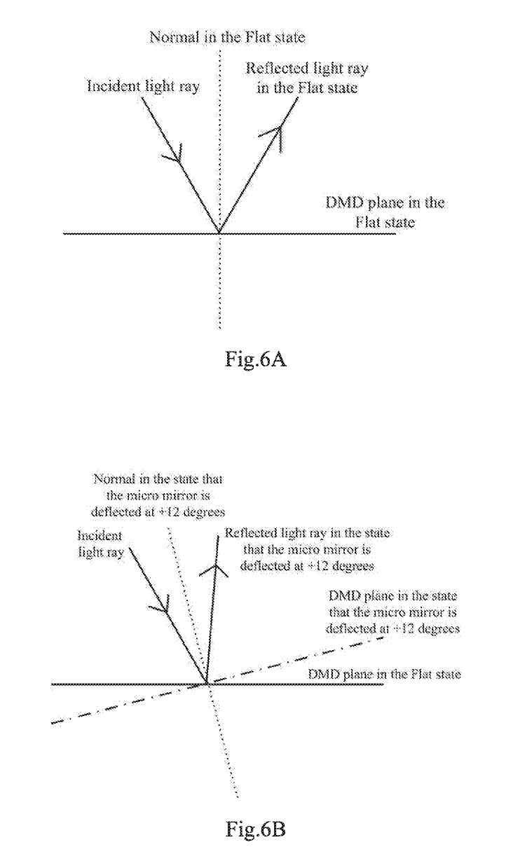

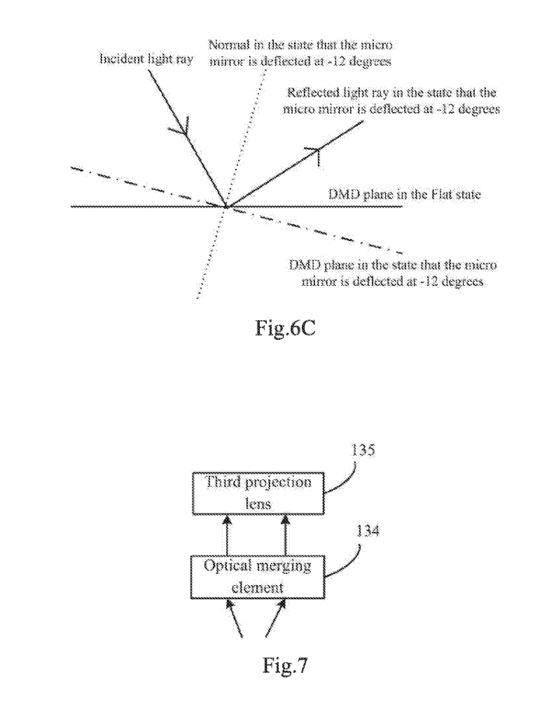

It shall be noted that the angle between the light rays of the light source at the first angle, and the light rays of the light source at the second angle, incident on the array of micro mirrors of the DMD is not equal to 48 degrees on the precondition that the micro mirrors in the array of micro mirrors on the DMD are deflected at 12 degrees from their initial arrangement state, for example, in which they can be arranged horizontally (i.e., a Flat state), or in another direction. A reason for this will be described below with reference to FIG. 6A, FIG. 6B, and FIG. 6C.

Any one of the micro mirrors in the array of micro mirrors on the DMD can be in three states respectively dependent upon the deflection angles thereof, i.e., a Flat state (as illustrated in FIG. 6A), an ON state (as illustrated in FIG. 6B), and an OFF state (as illustrated in FIG. 6C). If the micro mirror is not deflected, then it will be in the Flat state; if the micro mirror is deflected at +12 degrees, then it will be in the ON state; and if the micro mirror is deflected at −12 degrees, then it will be in the OFF state. If some light ray is incident on the micro mirror at any angle, then there will be angle of 48 degrees between the reflected light ray when the micro mirror being deflected by +12 degrees, and the reflected light ray when the micro mirror being deflected by −12 degrees as per the reflection principle of light. The DMD projection system generally images using the reflected light ray in the ON state but not the reflected light ray in the OFFstate, the latter of which is generally absorbed by a light absorber. If the light rays of the two light sources are incident on the array of micro mirrors of the DMD at the different angles, and there is an angle of 48 degrees between the light rays of the light source at the first angle, and the light rays of the light source at the second angle, and as per the reflection principle of light, the reflected light rays of one of the light rays of the light sources at one angle, when the micro mirrors are deflected by −12 degrees may lie in the same direction as, that is, overlap with, the reflected light rays of the other one of the light rays of the light sources at the other angle, when the micro mirrors are deflected by +12 degrees, and since the reflected light rays in the OFF state (the micro mirrors being deflected by −12 degrees) are absorbed so that the other one of the light rays of the light sources at the other angle, when the micro mirrors are deflected by +12 degrees are absorbed, there may be a resulting loss of the available light rays, thus lowering the brightness of imaging, and degrading the quality of imaging. In view of this, the angle between the light rays of the light source at the first angle, and the light rays of the light source at the second angle, incident on the array of micro mirrors of the DMD is not equal to 48 degrees in an embodiment of the application. Preferably the angle between the light rays of the light source at the first angle, and the light rays of the light source at the second angle, incident on the array of micro mirrors of the DMD can be less than 48 degrees, i.e., in a range of angles less than twice a range of angles of the DMD, so that the reflected light rays when the micro mirrors being deflected by −12 degrees of the preceding beam of light will not affect the reflected light rays when the micro mirrors being deflected by +12 degrees of the succeeding beam of light.

As illustrated in FIG. 7, the imaging module 15 includes an optical merging element 134 and a projection lens 135, where:

The optical merging element 134 is configured to vary the directions of the reflected light rays corresponding to the respective pixels of the first part of image emitted by the DMD 14, and/or the directions of the reflected light rays corresponding to the respective pixels of the second part of image emitted by the DMD 14 so that they are incident in parallel onto different areas of the projection lens 135; and in an implementation, since the light rays of the light source at the first angle, and the light rays of the light source at the second angle, modulated by the DMD 14 are incident on the optical merging element 134 at different angles or positions, the optical merging element 134 can be further configured to uniformize the light rays entering the projection lens 135 using a uniformizing element so that the first part of image and the second part of image are displayed at uniform brightness as a result of projection.

The projection lens 135 is configured to focus and image the reflected light rays corresponding to the respective pixels of the first part of image, emitted by the DMD 14, passing through the optical merging element 134, in the first imaging area 161 of the display screen 16 (that is, to display the first part of image) according to the corresponding relationship between an angle and an imaging area; and to focus and image the reflected light rays corresponding to the respective pixels of the second part of image, emitted by the DMD 14, passing through the optical merging element 134, in the second imaging area 162 of the display screen 16 (that is, to display the second part of image) according to the corresponding relationship between an angle and an imaging area, where the parts of image in the first imaging area 161 and the second imaging area 162 constitute the entire image; and the corresponding relationship between an angle and an imaging area defines that the light rays of the light source at the first angle correspond to the first imaging area of the display screen, and the light rays of the light source at the second angle correspond to the second imaging area of the display screen.

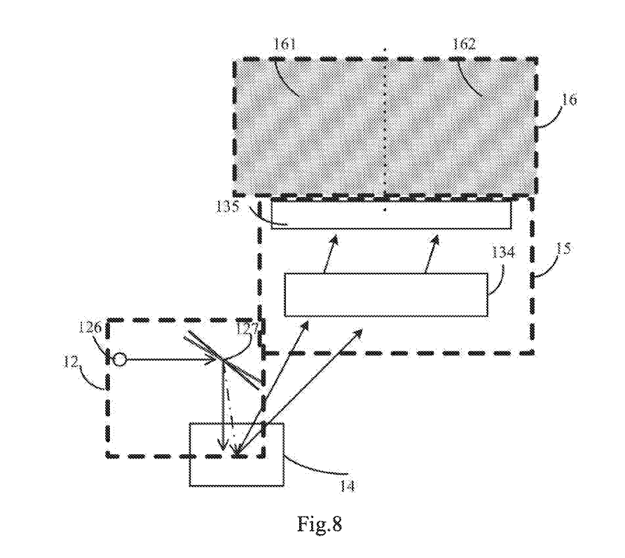

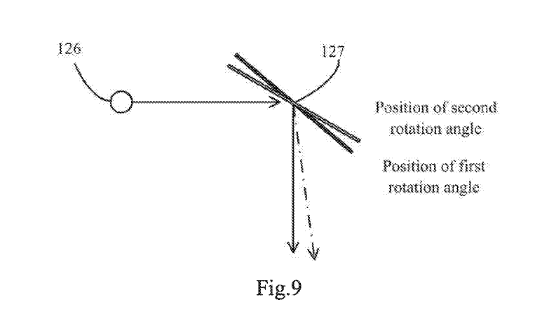

Referring to FIG. 8 illustrating another projection display system according to some embodiments of the application, the projection display system is different from the projection display system illustrated in FIG. 3 only in the light source module 12, so the light source module 12 illustrated in FIG. 8 will be described below with reference to FIG. 9, and reference can be made to FIG. 4 to FIG. 7, and the description thereof for details of the other components, a repeated description of which will be omitted here.

As illustrated in FIG. 9, the light source module 12 includes a light source 126, in an optical path of which a reflecting mirror 127 which can be rotated in a time order, and a light source control apparatus (not illustrated in FIG. 8 and FIG. 9) are arranged, where the reflecting mirror 127 is positioned to be rotated at the first angle and the second angle; the light source 126 is configured to be lightened constantly, and to output the light rays at the first angle, and the light rays at the second angle corresponding to the position of the first rotation angle, and the position of the second rotation angle respectively to illuminate the DMD 14; and the light source control apparatus is configured to receive the synchronization control signal emitted by the synchronization control apparatus, and to control the reflecting mirror 127 in response to the synchronization control signal to be rotated in a time order to the position of the first rotation angle, or the position of the second rotation angle, where the light source can be an ultra-high pressure mercury lamp light source, a LED light source, a laser light source, etc., and the laser light source is preferred.

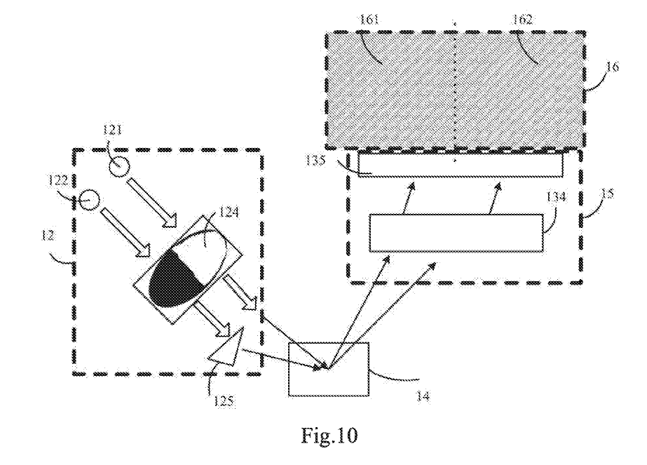

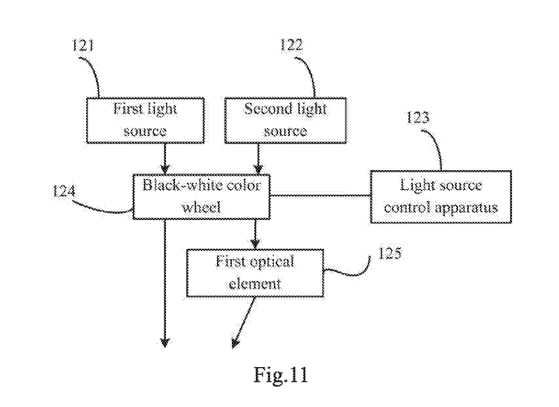

Referring to FIG. 10 illustrating another projection display system according to some embodiments of the application, the projection display system is different from the projection display system illustrated in FIG. 3 only in the light source module 12, so the light source module 12 illustrated in FIG. 10 will be described below with reference to FIG. 11, and reference can be made to FIG. 4 to FIG. 7, and the description thereof for details of the other components, a repeated description of which will be omitted here.

As illustrated in FIG. 11, the light source module 12 includes a first light source 121, a second light source 122, a black-white color wheel 124, a light source control apparatus 123, and a first optical element 125, where:

The light rays emitted by the first light source 121 and the second light source 122 are incident in parallel on the black-white color wheel 124; the light source control apparatus 123 is configured to receive the synchronization control signal emitted by the synchronization control apparatus, and to control the black-white color wheel 124 in response to the synchronization control signal to be rotated in a time order so that the light rays emitted by the first light source 121 and the second light source 122 illuminate alternately the array of micro mirrors of the DMD 14 respectively at the first angle and the second angle; the black-white color wheel 124 is configured to be controlled by the light source control apparatus 123 to block the light rays emitted by the first light source 121 and the second light source 122 from being transmitted through the black-white color wheel 124 so that the light of only one of the light sources can illuminate the DMD at a time; and the first optical element 125 (which can be a prism or a reflecting mirror, for example) is configured to vary the direction of the light rays, emitted by the second light source 122, transmitted through the black-white color wheel 124 so that the direction-varied light rays emitted by the second light source 122 illuminate the array of micro mirrors of the DMD 14 at a different angle from the light rays emitted by the first light source 121, where the light sources can be ultra-high pressure mercury lamp light sources, LED light sources, laser light sources, etc., and the laser light sources are preferred; and either of the first light source and the second light source can illuminate all the DMD.

Of course, the first optical element 125 can alternatively be configured to vary the direction of the light rays, emitted by the first light source 121, transmitted through the black-white color wheel 124 so that the direction-varied light rays emitted by the first light source 121 illuminate the array of micro mirrors of the DMD 14 at a different angle from the light rays emitted by the second light source 122.

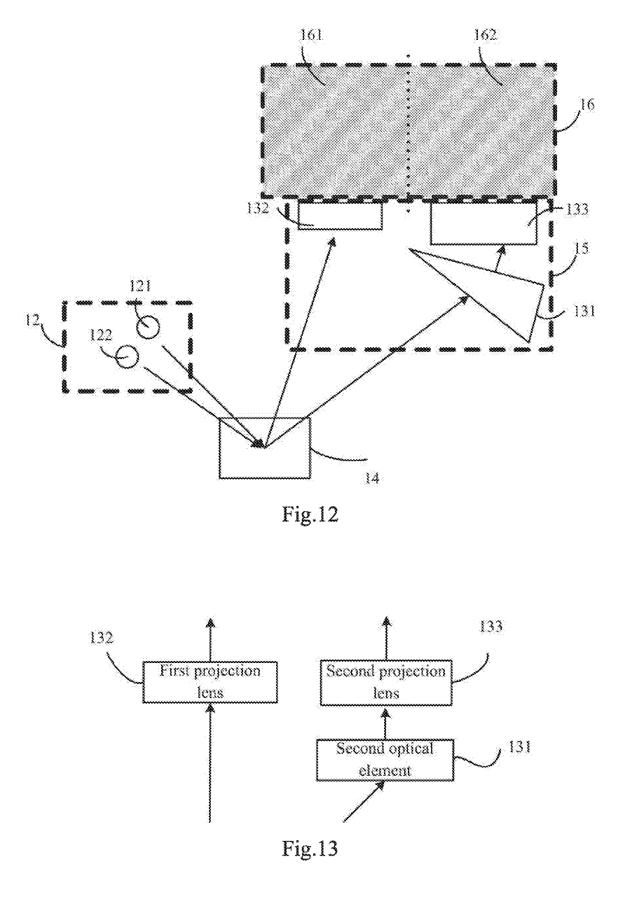

Referring to FIG. 12 illustrating another projection display system according to some embodiments of the application, the projection display system is different from the projection display system illustrated in FIG. 3 only in the imaging module 15, so the imaging module 15 illustrated in FIG. 112 will be described below with reference to FIG. 13, and reference can be made to FIG. 4 to FIG. 7, and the description thereof for details of the other components, a repeated description of which will be omitted here.

As illustrated in FIG. 13, the imaging module 15 includes a second optical element 131, a first projection lens 132, and a second projection lens 133, where:

The second optical element 131 (which can be a prism or a reflecting mirror, for example) is configured to vary the directions of the reflected light rays corresponding to the respective pixels of the second part of image emitted by the DMD 14 so that the directions of the direction-varied reflected light rays, incident on the second projection lens 133, corresponding to the respective pixels of the second part of image emitted by the DMD 14 are in parallel with the directions of the reflected light rays, incident on the first projection lens 132, corresponding to the respective pixels of the first part of image emitted by the DMD 14; the first projection lens 132 is configured to focus and image the reflected light rays corresponding to the respective pixels of the first part of image, emitted by the DMD 14, in the first imaging area 161 of the display screen 16 (that is, to display the first part of image) according to the corresponding relationship between an angle and an imaging area; and the second projection lens 133 is configured to focus and image the direction-varied reflected light rays corresponding to the respective pixels of the second part of image emitted by the DMD 14, in the second imaging area 162 of the display screen 16 (that is, to display the second part of image) according to the corresponding relationship between an angle and an imaging area, where the parts of image in the first imaging area 161 and the second imaging area 162 constitute the entire image; and the corresponding relationship between an angle and an imaging area defines that the light rays of the light source at the first angle correspond to the first imaging area of the display screen, and the light rays of the light source at the second angle correspond to the second imaging area of the display screen.

Of course, the second optical element 131 can alternatively be configured to vary the directions of the reflected light rays corresponding to the respective pixels of the first part of image emitted by the DMD 14 so that the directions of the direction-varied reflected light rays, incident on the first projection lens 132, corresponding to the respective pixels of the first part of image emitted by the DMD 14 are in parallel with the directions of the reflected light rays, incident on the second projection lens 133, corresponding to the respective pixels of the second part of image emitted by the DMD 14.

It shall be noted that the projection display systems according to the embodiments of the application are generally calibrated for splicing image before they are shipped from a factory, and the projection display systems including the two projection lens for focusing and imaging according to the embodiments of the application need to be further calibrated for splicing image before they are initially put into use, where they can be calibrated for splicing image as in a method for splicing image components in the prior art so that the imaging modules of the projection display systems being used by their users can splice the two parts of image into the entire image.

Additionally if the resolution of the DMD is 4K*2K, then it can be appreciated that the DMD includes 4K*2K micro mirrors, each of which corresponds to one of pixels in the image. The resolution of the picture imaging by the existing projection system with a single DMD is 4K*2K, whereas the resolution of the picture imaging by the projection display systems according to the embodiments of the application can be 8K*2K if the left and right parts of image are spliced, and 4K*4K if the upper and lower parts of image are spliced, that is, the resolution of the image in the single dimension can be improved.

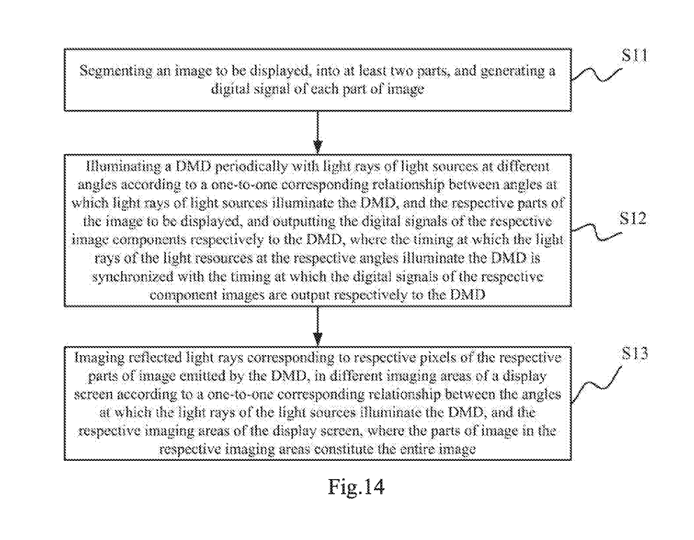

As illustrated in FIG. 14, an embodiment of the application provides a projection display method including the following operations:

S11. Segmenting an image to be displayed, into at least two parts, and generating a digital signal of each part of image;

S12. Illuminating a Digital Micro-mirror Device (DMD) periodically with light rays of light sources at different angles according to a one-to-one corresponding relationship between angles at which light rays of light sources illuminate the DMD, and the respective parts of image to be displayed, and outputting the digital signals of the respective parts of image respectively to the DMD, where the timing at which the light rays of the light resources at the respective angles illuminate the DMD is synchronized with the timing at which the digital signals of the respective parts of image are output respectively to the DMD; and

S13. Imaging reflected light rays corresponding to respective pixels of the respective parts of image emitted by the DMD, in different imaging areas of a display screen according to a one-to-one corresponding relationship between the angles at which the light rays of the light sources illuminate the DMD, and the respective imaging areas of the display screen, where the parts of image in the respective imaging areas constitute the entire image.

Particularly the one-to-one corresponding relationship between angles at which light rays of light sources illuminate the DMD, and the respective parts of the image to be displayed is the corresponding relationship between an angle and the part of image.

The one-to-one corresponding relationship between the angles at which the light rays of the light sources illuminate the DMD, and the respective imaging areas of the display screen is the corresponding relationship between an angle and an imaging area.

It shall be noted that the image in the respective imaging areas can be spliced into the entire image as in the method for splicing image in the prior art.

In some implementations, the DMD can be illuminated periodically with the light rays of the light sources at the different angles by light sources arranged at a number of angles being lightened in a time order to thereby emit light rays periodically to illuminate the DMD; or by a light source being lightened constantly, in an optical path of which a reflecting mirror positioned to be rotated at a number of angles is arranged, where the reflecting mirror is rotated in a time order to thereby output the light rays at corresponding one of the angles for any one of the rotation angles to illuminate the DMD. Of course, the DMD can alternatively be otherwise illuminated periodically with the light rays of the light sources at the different angles. Any one of the light sources can be an ultra-high pressure mercury lamp light source, an LED light source, a laser light source, etc., and the laser light source is preferred.

The image is generally displayed in the projection display method according to any one of the embodiments of the application in a similar operating process, and particularly a projection display method according to an embodiment of the application will be described below by way of an example in which an image is segmented into and displayed as two parts.

The first operation is to segment an image to be displayed into two parts (i.e., a first and a second parts), and to generate a digital signal of each part of image, where the first part of image and the second part of image are respective halves of the image to be displayed, and the first part of image and the second part of image can be the left and right halves, or the upper and lower halves thereof;

The second operation is to illuminate a DMD with light rays of a light source at a first angle, to output the digital signal of the first part of image to the DMD, and to image reflected light rays corresponding to respective pixels of the first part of image emitted by the DMD, in a first imaging area of a display screen; and

The third operation is to illuminate a DMD with light rays of a light source at a second angle, to output the digital signal of the second part of image to the DMD, and to image reflected light rays corresponding to respective pixels of the second part of image emitted by the DMD, in a second imaging area of the display screen, where the parts of image in the first imaging area and the second imaging area constitute the entire image.

In summary, with the technical solutions according to the embodiments of the application, for any parts of the image to be displayed, the DMD is illuminated by the light rays of the light source at the corresponding one of the angles at which the light rays emitted by the light source module illuminate the DMD, and projects the part of image in the corresponding one of the imaging areas of the display screen in response to a driver signal corresponding to the part of image, according to the corresponding relationship between the one angle and the one part of image to be displayed, and the corresponding relationship between the one angle, and the one imaging area of the display screen, so when the respective parts of the image to be displayed are displayed in the respective imaging areas of the display screen, the parts of image in the respective imaging areas constitute the entire image. Since the entire image on the display screen consists of the parts of image projected by the same DMD in the respective imaging areas in a time-division mode, the picture can be displayed at a higher resolution without increasing the number of DMDs.

Those skilled in the art shall appreciate that the embodiments of the application can be embodied as a method, a system or a computer program product. Therefore the application can be embodied in the form of an all-hardware embodiment, an all-software embodiment or an embodiment of software and hardware in combination. Furthermore the application can be embodied in the form of a computer program product embodied in one or more computer useable storage mediums (including but not limited to a disk memory, an optical memory, etc.) in which computer useable program codes are contained.

The application has been described in a flow chart and/or a block diagram of the method, the device (system) and the computer program product according to the embodiments of the application. It shall be appreciated that respective flows and/or blocks in the flow chart and/or the block diagram and combinations of the flows and/or the blocks in the flow chart and/or the block diagram can be embodied in computer program instructions. These computer program instructions can be loaded onto a general-purpose computer, a specific-purpose computer, an embedded processor or a processor of another programmable data processing device to produce a machine so that the instructions executed on the computer or the processor of the other programmable data processing device create means for performing the functions specified in the flow(s) of the flow chart and/or the block(s) of the block diagram.

These computer program instructions can also be stored into a computer readable memory capable of directing the computer or the other programmable data processing device to operate in a specific manner so that the instructions stored in the computer readable memory create an article of manufacture including instruction means which perform the functions specified in the flow(s) of the flow chart and/or the block(s) of the block diagram.

These computer program instructions can also be loaded onto the computer or the other programmable data processing device so that a series of operational steps are performed on the computer or the other programmable data processing device to create a computer implemented process so that the instructions executed on the computer or the other programmable device provide steps for performing the functions specified in the flow(s) of the flow chart and/or the block(s) of the block diagram.

Evidently those skilled in the art can make various modifications and variations to the application without departing from the spirit and scope of the application. Thus the application is also intended to encompass these modifications and variations thereto so long as the modifications and variations come into the scope of the claims appended to the application and their equivalents.

1. A projection display system, comprising a light source module, a Digital Micro-mirror Device (DMD), and an imaging module, wherein:
the light source module is configured to illuminate the DMD with light rays emitted periodically at different angles;
the DMD is configured to receive the light rays emitted by the light source module according to a corresponding relationship between an angle and a part of image, and to reflect the received light rays emitted by the light source module in response to a driver signal corresponding to any part of image to be displayed, to thereby generate and transmit reflected light rays corresponding to respective pixels of the part of image to the imaging module, wherein the corresponding relationship between an angle and a part of image defines that an angle at which the light rays emitted by the light source module illuminate the DMD corresponds to one part of the image to be displayed; and
the imaging module is configured to image the reflected light rays, emitted by the DMD, corresponding to the respective pixels in the respective parts of image, in different imaging areas of a display screen according to a corresponding relationship between an angle and an imaging area, wherein the respective parts of image constitute the entire image; and the corresponding relationship between an angle and an image area defines that an angle at which the light rays emitted by the light source module illuminate the DMD corresponds to one of the imaging areas of the display screen.

2. The projection display system according to claim 1, wherein the light source module comprises a number of light sources arranged at different angles, and the light sources are lightened in a time order to thereby emit light rays periodically to illuminate the DMD; or
the light source module comprises one light source, in an optical path of which a reflecting mirror which can be rotated in a time order is arranged, wherein the reflecting mirror is positioned to be rotated at a number of angles; and the light source is lightened constantly to output light rays at a corresponding angle for any one of the rotation angles to illuminate the DMD.

3. The projection display system according to claim 1, wherein the imaging module comprises an optical merging element and a projection lens, wherein:
the optical merging element is configured to adjust the directions of the reflected light rays corresponding to the respective pixels of the respective parts of image emitted by the DMD so that they are incident onto different areas of the projection lens; and
the projection lens is configured to focus and image the reflected light rays corresponding to the respective pixels of the respective parts of image, emitted by the DMD, passing through the optical merging element, in the different imaging areas of the display screen, according to the corresponding relationship between an angle and an imaging area.

4. The projection display system according to claim 2, wherein if the light source module comprises a first light source and a second light source, which are arranged at two different angles, then the first light source and the second light source are lightened in a time order to thereby emit light rays alternately at a first angle and a second angle to illuminate the DMD.

5. The projection display system according to claim 4, wherein there is such an angle between the light rays emitted by the first light source at the first angle, and the light rays emitted by the second light source at the second angle that is not equal to 48 degrees if micro mirrors in an array of micro mirrors on the DMD are deflected at 12 degrees.

6. The projection display system according to claim 4, wherein the DMD is configured to receive the light rays of the light source at the first angle, and to reflect the light rays of the light source at the first angle in response to a driver signal corresponding to a first part of the image to be displayed to generate reflected light rays corresponding to respective pixels of the first part of image to the imaging module; and to receive the light rays of the light source at the second angle, and to reflect the light rays of the light source at the second angle in response to a driver signal corresponding to a second part of the image to be displayed to generate reflected light rays corresponding to respective pixels of the second part of image to the imaging module, according to a timing at which the light rays of the light source at the first angle, and the light rays of the light source at the second angle are output, and the corresponding relationship between an angle and a part of image, where the first and the second parts of image constitute the entire image to be displayed.

7. The projection display system according to claim 6, wherein the imaging module comprises an optical merging element and a projection lens, wherein:
the optical merging element is configured to vary the directions of the reflected light rays corresponding to the respective pixels of the first part of image emitted by the DMD, and/or the directions of the reflected light rays corresponding to the respective pixels of the second part of image emitted by the DMD so that they are incident in parallel onto different areas of the projection lens; and
the projection lens is configured to focus and image the reflected light rays corresponding to the respective pixels of the first part of image, emitted by the DMD, passing through the optical merging element, in a first imaging area of the display screen according to the corresponding relationship between an angle and an imaging area; and to focus and image the reflected light rays corresponding to the respective pixels of the second part of image, emitted by the DMD, passing through the optical merging element, in a second imaging area of the display screen according to the corresponding relationship between an angle and an imaging area, wherein the parts of image in the first imaging area and the second imaging area constitute the entire image.

8. The projection display system according to claim 2, wherein if the light source module comprises a light source, then a reflecting mirror which can be rotated in a time order will be arranged in an optical path of the light source, wherein the reflecting mirror is positioned to be rotated at a first angle and a second angle; and the light source is configured to be lightened constantly, and to output light rays at the first angle, and light rays at the second angle corresponding to the position of the first rotation angle, and the position of the second rotation angle to illuminate the DMD.

9. The projection display system according to claim 8, wherein there is such an angle between the light rays at the first angle, and the light rays at the second angle that is not equal to 48 degrees if micro mirrors in an array of micro mirrors on the DMD are deflected at 12 degrees.

10. The projection display system according to claim 8, wherein the DMD is configured to receive the light rays of the light source at the first angle, and to reflect the light rays of the light source at the first angle in response to a driver signal corresponding to a first part of the image to be displayed to generate reflected light rays corresponding to respective pixels of the first part of image to the imaging module; and to receive the light rays of the light source at the second angle, and to reflect the light rays of the light source at the second angle in response to a driver signal corresponding to a second part of the image to be displayed to generate reflected light rays corresponding to respective pixels of the second part of image to the imaging module, according to a timing at which the light rays of the light source at the first angle, and the light rays of the light source at the second angle are output, and the corresponding relationship between an angle and a part of image, where the first and the second parts of image constitute the entire image to be displayed.

11. The projection display system according to claim 10, wherein the imaging module comprises an optical merging element and a projection lens, wherein:
the optical merging element is configured to vary the directions of the reflected light rays corresponding to the respective pixels of the first part of image emitted by the DMD, and/or the directions of the reflected light rays corresponding to the respective pixels of the second part of image emitted by the DMD so that they are incident in parallel onto different areas of the projection lens; and
the projection lens is configured to focus and image the reflected light rays corresponding to the respective pixels of the first part of image, emitted by the DMD, passing through the optical merging element, in a first imaging area of the display screen according to the corresponding relationship between an angle and an imaging area; and to focus and image the reflected light rays corresponding to the respective pixels of the second part of image, emitted by the DMD, passing through the optical merging element, in a second imaging area of the display screen according to the corresponding relationship between an angle and an imaging area, wherein the parts of image in the first imaging area and the second imaging area constitute the entire image.

12. The projection display system according to claim 2, wherein any one of the light sources is a Light Emitting Diode (LED) light source or a laser light source.

13. The projection display system according to claim 1, further comprising a signal processing system configured to segment the image to be displayed into at least two parts, to generate a digital signal of each part of image, and to output the digital signals of the respective part of image respectively to the DMD.

14. The projection display system according to claim 13, wherein further comprising a synchronization control apparatus configured to generate and transmit a synchronization control signal respectively to the signal processing system and the light source module, wherein the synchronization control signal is configured to control the timing at which the light rays emitted by the light source module illuminate the DMD to be synchronized with the timing at which the signal processing system outputs the digital signals of the respective image components to the DMD, according to the corresponding relationship between an angle and a part of image.

15. A projection display method, comprising:
segmenting an image to be displayed, into at least two parts, and generating a digital signal of each part of the image;
illuminating a Digital Micro-mirror Device (DMD) periodically with light rays of light sources at different angles according to a one-to-one corresponding relationship between angles at which light rays of light sources illuminate the DMD, and respective parts of the image to be displayed, and outputting digital signals of the respective parts of image respectively to the DMD, wherein a timing at which the light rays of the light resources at the respective angles illuminate the DMD is synchronized with a timing at which the digital signals of the respective parts of image are output respectively to the DMD; and
imaging reflected light rays corresponding to respective pixels of the respective parts of image emitted by the DMD, in different imaging areas of a display screen according to a one-to-one corresponding relationship between the angles at which the light rays of the light sources illuminate the DMD, and the respective imaging areas of the display screen, wherein the parts of image in the respective imaging areas constitute the entire image.

16. The method according to claim 15, wherein operation that illuminating the DMD periodically with the light rays of the light sources at different angles comprises:
lighting light sources arranged at a number of angles in a time order to thereby emit light rays periodically to illuminate the DMD; or
the operation that illuminating the DMD periodically with the light rays of the light sources at the different angles comprises:
lightening a light source constantly, and arranging a reflecting mirror positioned to be rotated at a number of angles, in an optical path of the light source, wherein the reflecting mirror is rotated in a time order to thereby output light rays at corresponding one of the angles for any one of the rotation angles to illuminate the DMD.

17. The method according to claim 16, wherein if the light sources arranged at the number of angles comprise a first light source and a second light source, which are arranged at two different angles, then the first light source and the second light source will be lightened in the time order to thereby emit light rays alternately at a first angle and a second angle to illuminate the DMD.

18. The method according to claim 17, wherein there is such an angle between the light rays emitted by the first light source at the first angle, and the light rays emitted by the second light source at the second angle that is not equal to 48 degrees if micro mirrors in an array of micro mirrors on the DMD are deflected at 12 degrees.

19. The method according to claim 15, wherein if the reflecting mirror positioned to be rotated at a first angle and a second angle is arranged in an optical path of the light source, then the reflecting mirror will be rotated in a time order to thereby output light rays at the first angle for the position of the first rotation angle, and light rays at the second angle for the position of the second rotation angle to illuminate the DMD.

20. The method according to claim 19, wherein there is such an angle between the light rays at the first angle, and the light rays at the second angle that is not equal to 48 degrees if micro mirrors in an array of micro mirrors on the DMD are deflected at 12 degrees.
